(19) United States
(12) Patent Application Publication
(10) Pub. No.: US 2009/0236176 A1
(43) Pub. Date: Sep. 24, 2009

(54) Integrated harness boiler suit

(76) Inventor: Jia-Peir SHEU, Mailiao Hsiang (TW)

Correspondence Address: CHARLES E. BAXLEY, ESQUIRE, 90 JOHN STREET, SUITE 309, NEW YORK, NY, 10038, US

(21) Appl. No.: 12/077,999

(22) Filed: Mar. 24, 2008

(51) Int. Cl. A62B 35/00; A41D 13/00

(52) U.S. Cl. 182/3; 2/69

(57) ABSTRACT

An integrated harness boiler suit has a body and a safety harness. The body has a trunk and multiple limbs. The trunk has multiple limb openings corresponding to a wearer's limbs, an access opening formed centrally in the trunk so a wearer can put on and remove the suit and a linking component for opening and closing. The safety harness is sewn on the body and has a chest binding sewn on the trunk for strengthening closure of the access opening and a connecting leash sewn on the trunk for connecting to a fixture or other person using a line. The integrated boiler suit is convenient to wear, requires no training to be worn safely and may be worn quickly and safely in emergencies.

### BACKGROUND OF THE INVENTION

1. Field of the Invention

The present invention relates to a boiler suit, and more particularly to an integrated harness boiler suit that can be worn easily and safely.

2. Description of Related Art

Many workers, especially construction workers, high-rise window cleaners, engineers, sailors, rescue workers and the like are exposed to a danger of falling during their jobs so their personal protection equipment includes a conventional safety belt. The conventional safety belt is also used recreationally by rock climbers, mountain climbers, skiers and the like. The conventional belt is worn around a wearer's waist and connects the wearer to a fixture or friend, maybe via a rope, cable or the like, and thus prevents the wearer from falling a great distance. However, the conventional safety belt worn around the waist of the wearer provides a strong pulling force concentrated in one location should the wearer fall from high altitude before being stopped this strong pulling force may cause injuries. Furthermore, the belt cannot fully protect from upside down falls since the wearer may fall out headfirst.

With reference to FIGS. 6 and 7, a conventional safety harness (90) comprises two body straps (91), a chest strap (94), multiple adjustment devices (92) and a connecting ring (93). Each body strap (91) has two ends, one end is formed as an adjustable loop using an adjustment device (92) and is worn around a first leg. The other end crosses over a back through the connecting ring (93) and worn down an opposing side and is connected to the loop of the other body strap (91) worn on a second leg to form an arm loop using one adjustment device (92). The chest strap (94) is adjustably connected between the body straps (91) using an adjustment device (92). The adjustment devices (92) are connected to the straps (91) near the limbs and the chest and are used to loosen or tighten the body. straps (91). The connecting ring (93) is mounted around the body straps (91) and is connected to a safety rope, line or the like.

The conventional safety harness (90) can provide protection but requires training to be worn properly since a correct orientation must be used. During an emergency, when the harness (90) must be worn quickly, the correct orientation and which loop corresponds to arms and legs as well as the body straps (91) becoming intertwined causes confusion, is time-consuming and inconvenient. In addition, when the wearer bends over, down or twists the straps (91) become distanced from the body and form sub-loops that an object may hook into and cause an accident.

To overcome the shortcomings, the present invention provides an integrated harness boiler suit to mitigate or obviate the aforementioned problems.

### SUMMARY OF THE INVENTION

The main objective of the present invention is to provide an integrated harness boiler suit that can be worn easily and safely.

The integrated harness boiler suit in accordance with the present invention has a body and a safety harness. The body has a trunk and multiple limbs. The trunk has multiple limb openings corresponding to a wearer's limbs, an access opening formed centrally in the trunk so a wearer can put on and remove the suit and a linking component for opening and closing. The safety harness is sewn on the body and has two shoulder straps, two leg protecting straps, a chest binding and a connecting leash. The shoulder straps are sewn around the trunk and cross at a back of the trunk. The leg protecting straps are respectively attached adjacent to the limb openings for legs and are sewn to the shoulder straps. The chest binding is sewn on the trunk and may be connected to the shoulder straps. The connecting leash is sewn on the trunk.

Other objectives, advantages and novel features of the invention will become more apparent from the following detailed description when taken in conjunction with the accompanying drawings.

### BRIEF DESCRIPTION OF THE DRAWINGS

FIG. 1 is a front view of an integrated harness boiler suit in accordance with the present invention;

FIG. 2 is a rear view of the integrated harness boiler suit in FIG. 1;

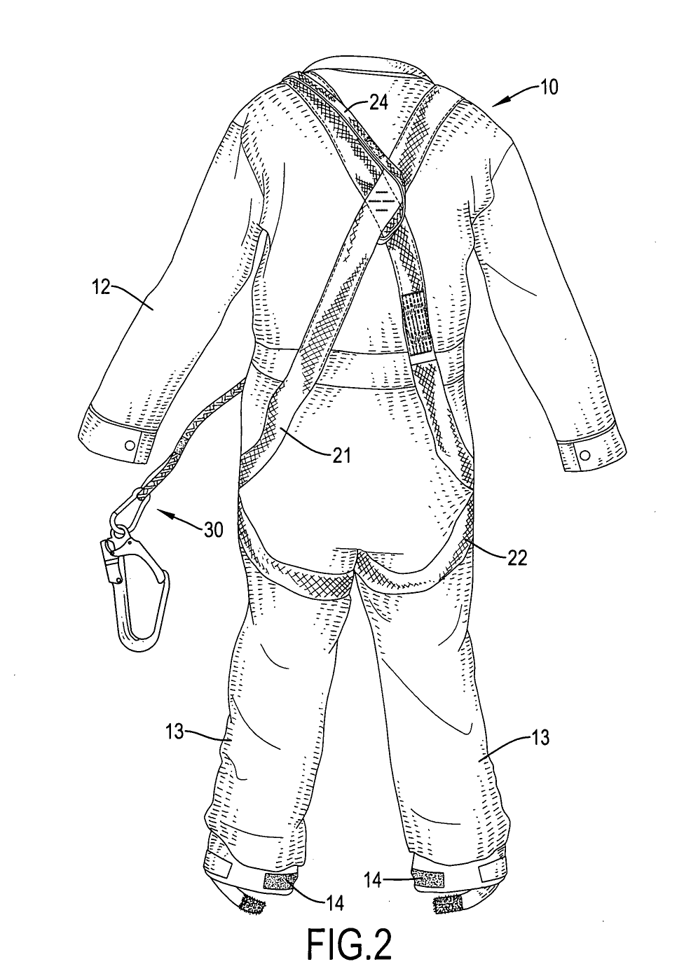

FIG. 3 is an operational rear view of the integrated harness boiler suit in FIG. 1;

FIG. 4 is a perspective front view of a second embodiment of an integrated harness boiler suit in accordance with the present invention;

FIG. 5 is a perspective front view of a third embodiment of an integrated harness boiler suit in accordance with the present invention;

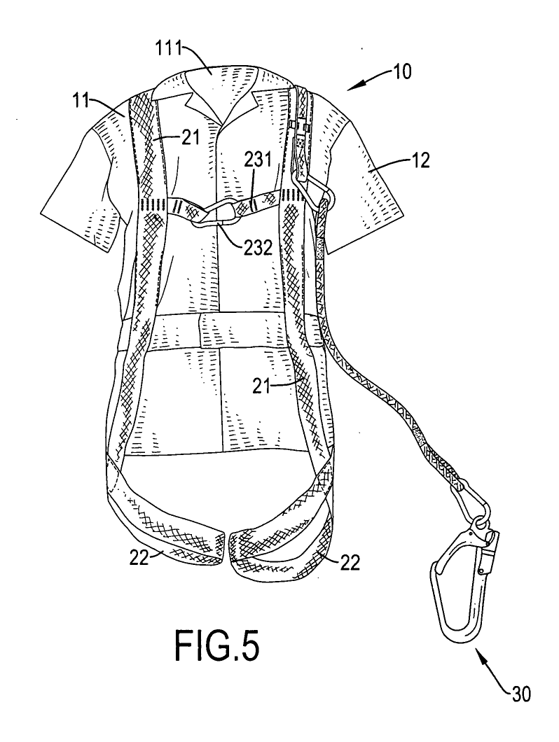

FIG. 6 is a front view of a conventional safety harness in accordance with the prior art; and

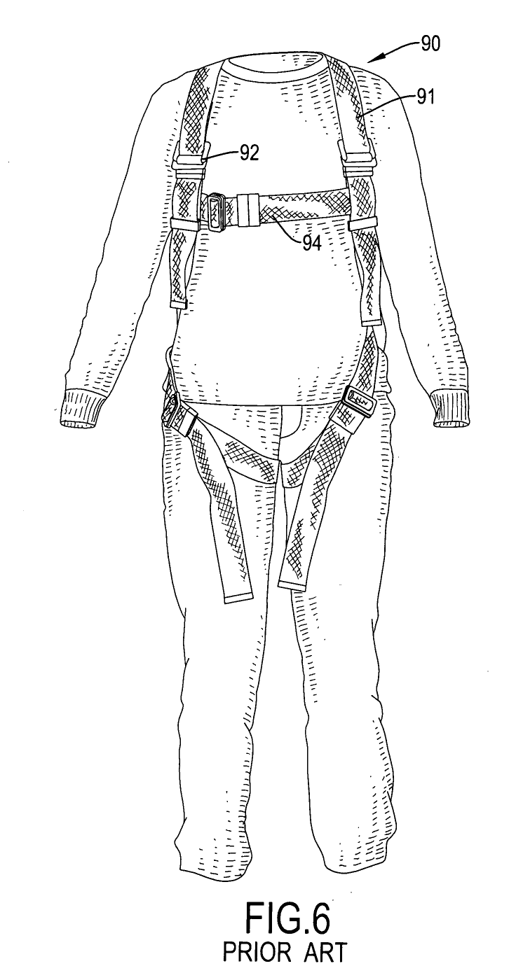

FIG. 7 is a rear view of the conventional safety harness in FIG. 6.

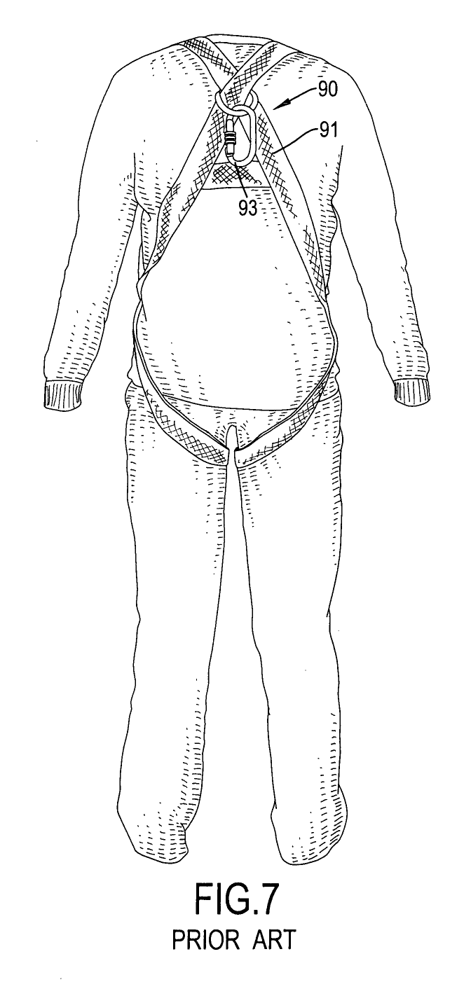

### DETAILED DESCRIPTION OF THE PREFERRED EMBODIMENT

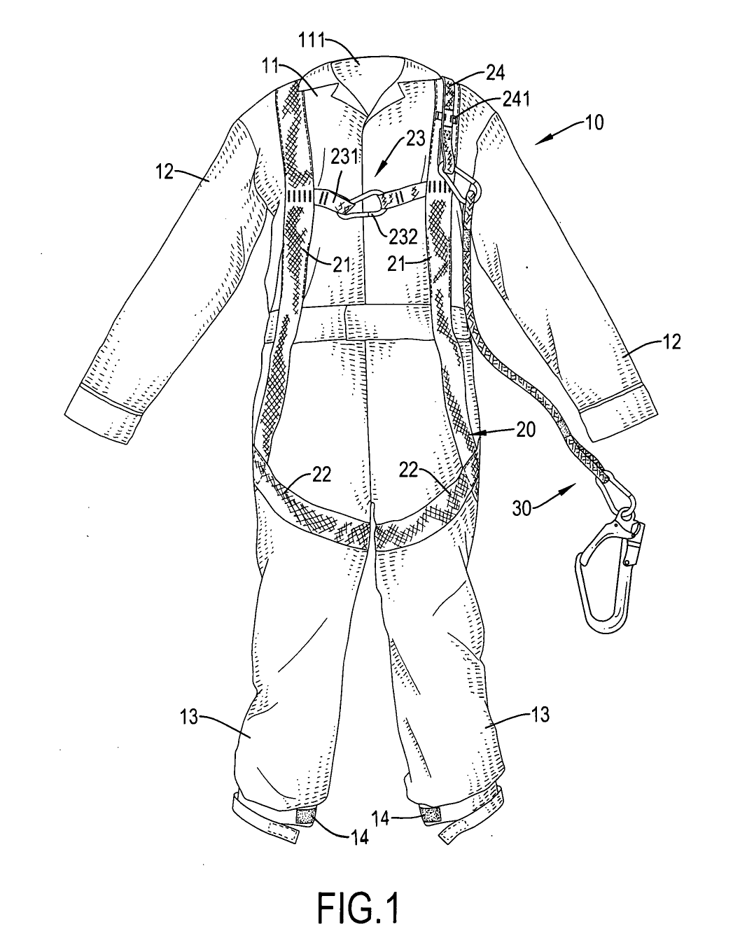

With reference to FIGS. 1 2 and 5, an integrated harness boiler suit in accordance with the present invention comprises a body (10) and a safety harness (20).

The body (10) has a trunk (11) and multiple limbs.

The trunk (11) has a front, a back, a neck end, a bottom end, multiple limb openings (111), an access opening and a linking component. The limb openings are formed corresponding to a wearer's neck, arms and legs. The access opening is centrally formed in the trunk (11) of the body (10). The linking component may be a zipper, hook and loop fastener, multiple buttons or the like and is formed adjacent to the access opening. The limbs are attached to the trunk (11) at corresponding limb openings (111) and may comprise a free end and cuff closures (14). The cuff closures (14) are attached to the free ends of the limbs and may be elastic, hook and loop fasteners, cord or the like and allow a wearer to alter a size of opening for comfort and safety. The limbs may comprise two sleeves (12) and two legs (13). The sleeves (12) may be short-sleeves or long-sleeves, where short sleeves do not cover an entire arm and long sleeves cover an entire arm. The legs (13) may be short legs or long legs, where short legs do not cover an entire leg and long legs cover the entire leg.

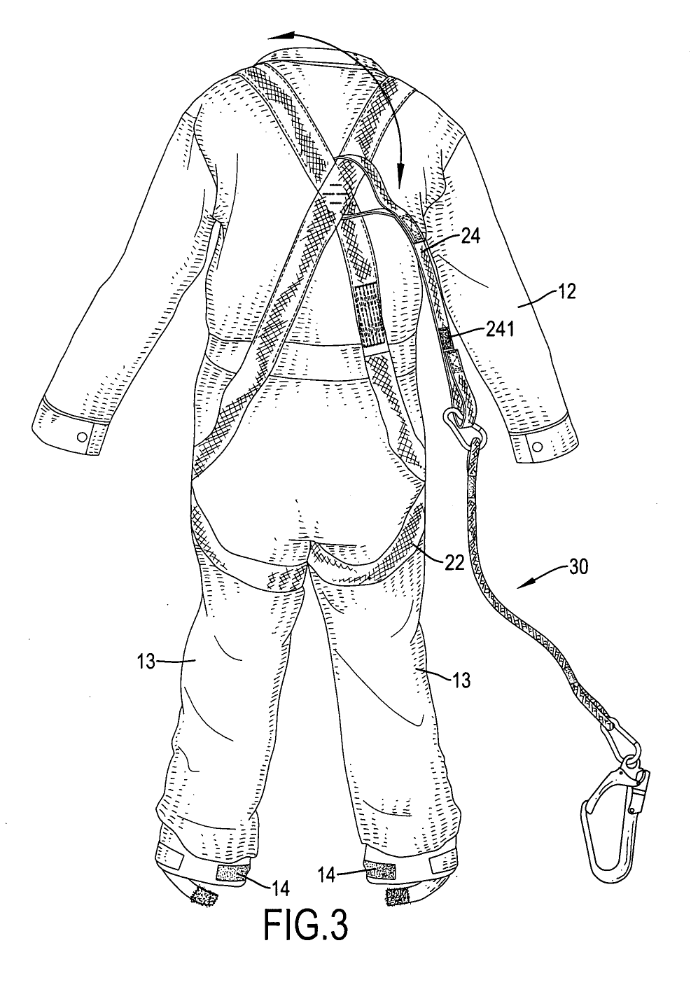

With further reference to FIG. 3, the safety harness (20) is sewn onto the body (10) and has two shoulder straps (21), two leg protecting straps (22), a chest binding (23) and a connecting leash (24). The shoulder straps (21) are respectively sewn around the trunk (11) of the body (10) adjacent to the limb openings (111) for arms, cross on the back of the trunk (11) and continue until adjacent to opposing limb openings (111) for legs. The leg protecting straps (22) are formed as loops and are respectively attached adjacent to the limb openings (111) for legs near the bottom of the trunk (11), may be sewn around the legs (13), and are sewn to the shoulder straps (21). The chest binding (23) is sewn on the front of the trunk (11) and may be connected to the shoulder straps (21) on the front of the trunk (11) and has two annular belts (231) and a retaining ring (232). The annular belts (231) are respectively sewn on the front of the trunk (11) and the shoulder straps (21). The retaining ring (232) is detachably hooked through the annular belts (231). The connecting leash (24) is wound around the shoulder straps (21) on the back of the trunk (11) and has a winding end, a connecting end and two fasteners (241). The winding end of the connecting leash (24) is wound around a crossing position of the shoulder straps (21) on the back of the trunk (11). One of the fasteners (241) is formed adjacent to the winding end of the connecting leash (24) and the other fastener is formed on a corresponding shoulder strap (21). The fasteners (241) may be hook and loop fasteners.

A safety rope (30) may be connected to the connecting end of the connecting leash (24).

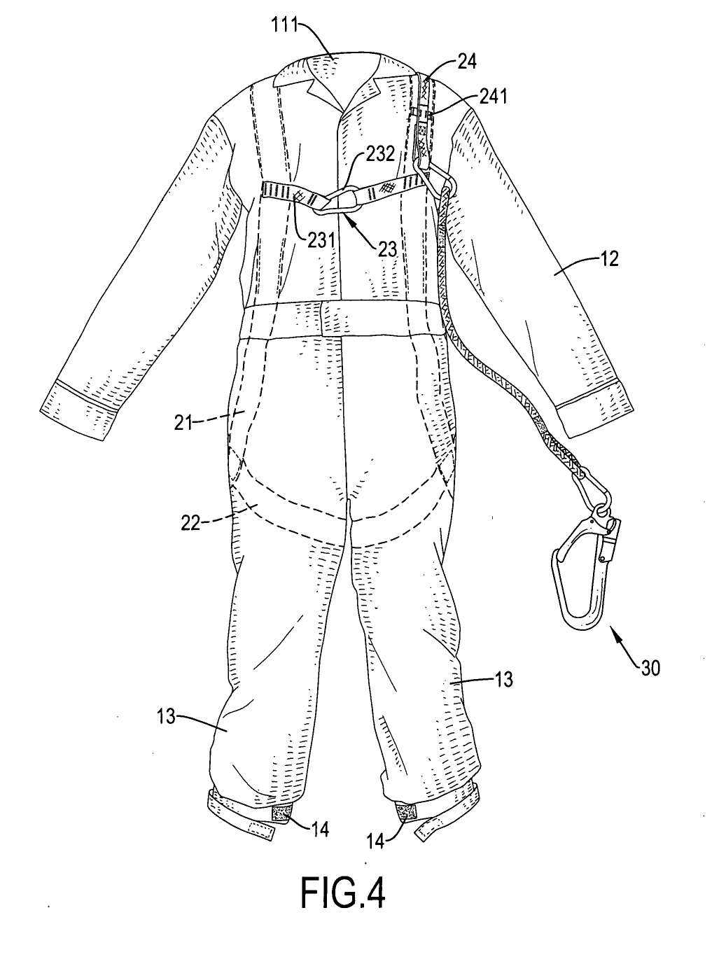

With further reference to FIG. 4, the straps (21, 22) may be sewn inside or outside the trunk (11) of the body (10).

The integrated harness boiler suit as described has the following advantages.

1. When a wearer puts the integrated harness boiler suit on, they only need to open the linking component of the trunk (11) and put the integrated harness boiler suit on the their body. Therefore, the wearer can dress or be dressed with the integrated harness boiler suit quickly and easily.

2. The shoulder straps (21) and the leg straps (22) are sewn on the body (10) and this can prevent the safety harness (20) from intertwining with itself.

3. The shoulder straps (21) fit a wearer's body so prevents the shoulder straps (21) from forming loops that may be hooked by an object and therefore improves safety of the integrated harness boiler suit.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An integrated harness boiler suit having
a body having
a trunk having
a front;
a back;
a neck end;
a bottom end;
multiple limb openings being formed corresponding to a wearer's neck, arms and legs;
an access opening being centrally formed in the trunk of the body; and
a linking component being formed adjacent to the access openings; and
a safety harness being sewn onto the body and having
a chest binding being sewn on the front of the trunk of the body; and
a connecting leash being wound on the back of the trunk of the body.

2. The integrated harness boiler suit as claimed in claim 1, wherein the body further has
multiple limbs being attached to the trunk at the limb openings and comprising two sleeves being sewn on the trunk near the opening.

3. The integrated harness boiler suit as claimed in claim 2, wherein the safety harness further has
two shoulder straps being respectively sewn around the trunk of the body adjacent to the limb openings for arms, cross on the back of the trunk and continue until adjacent to opposing limb openings for legs; and
two leg protecting straps being formed as loops and being respectively attached adjacent to the limb openings for legs near the bottom of the trunk and being sewn to the shoulder straps;
wherein the chest binding is connected to the shoulder straps on the front of the trunk and the connecting leash is sewn to an outside shoulder strap.

4. The integrated harness boiler suit as claimed in claim 3, wherein the straps are sewn inside the trunk of the body.

5. The integrated harness boiler suit as claimed in claim 3, wherein the straps are sewn outside the trunk of the body.

6. The integrated harness boiler suit as claimed in claim 3, wherein the connecting leash further has
a winding end being wound around a crossing position of the shoulder straps on the back of the trunk of the body;
a connecting end; and
two fasteners, and one of the fasteners being formed adjacent to the winding end of the connecting leash and the other fastener being formed on a corresponding shoulder strap.

7. The integrated harness boiler suit as claimed in claim 6, wherein the chest binding further has
two annular belts being respectively sewn on the front of the trunk and the shoulder straps; and
a retaining ring being detachably hooked through the annular belts.

8. The integrated harness boiler suit as claimed in claim 7, wherein
the limbs comprise two legs; and
the leg protecting straps are sewn around the legs.

9. The integrated harness boiler suit as claimed in claim 8, wherein at least one of the limbs further has
a free end; and
a cuff closure being formed at the free end allowing a wearer to alter a size of opening for comfort and safety.

10. The integrated harness boiler suit as claimed in claim 9, wherein the linking component and each one cuff closure are hook and loop fasteners.

11. The integrated harness boiler suit as claimed in claim 9, wherein the linking component is a zipper.

12. The integrated harness boiler suit as claimed in claim 9, wherein the linking component is multiple buttons.

13. The integrated harness boiler suit as claimed in claim 9, wherein a safety rope is connected to the connecting end of the connecting leash.
